(19) United States
(12) Patent Application Publication
(10) Pub. No.: US 2015/0075839 A1
(43) Pub. Date: Mar. 19, 2015

(54) ETHYLENE POLYMER CONDUCTOR COATINGS PREPARED WITH POLYBUTADIENE CROSS-LINKING COAGENTS

(71) Applicants: Yabin Sun, Shanghai (CN); Fanliang Meng, Shanghai (CN); Journey Lu Zhu, Shanghai (CN); Bin Li, Shanghai (CN)

(72) Inventors: Yabin Sun, Shanghai (CN); Fanliang Meng, Shanghai (CN); Journey Lu Zhu, Shanghai (CN); Bin Li, Shanghai (CN)

(73) Assignee: Dow Global Technologies LLC, Midland, MI (US)

(21) Appl. No.: 14/391,767

(22) PCT Filed: May 10, 2012
(86) PCT No.: PCT/CN12/75287

§ 371 Date: Oct. 10, 2014

(51) Int. Cl. H01B 3/30; H01B 13/06

(52) U.S. Cl. CPC H01B 3/307; H01B 13/06
USPC 174/110 PM; 427/120

(57) ABSTRACT

Processes for producing coated conductors with a polymeric coating composition and a cable resulting therefrom. The polymeric coating composition comprises an ethylene polymer, an organic peroxide, and a polybutadiene. The processes comprise coating conductors with the polymeric coating composition, cross-linking the polymeric coating composition, and degassing the resulting cross-linked polymeric coating composition.

### FIELD

Various embodiments of the present invention relate to polymeric coating compositions for making coated conductors. Other aspects of the invention concern polymeric coating compositions comprising polybutadiene cross-linking coagents.

### INTRODUCTION

Medium, high, and extra-high voltage (“MV,” “HV,” and “EHV”) cables typically contain a peroxide cross-linked ethylene polymer material as an insulation layer. Although cross-linking provides valuable improvement in thermomechanical properties of the material, the peroxide used for cross-linking creates byproducts that require removal from the material after it is formed into an insulation layer (e.g., by degassing) but before a jacketing layer is placed over the insulation layer. In the case of dicumyl peroxide, these byproducts include methane, acetophenone, alpha methylstyrene, and cumyl alcohol. Although work has been undertaken to discover an insulation material that does not require degassing, no viable solution has been identified. Accordingly, improvements are still desired.

### SUMMARY

One embodiment is a process for producing a coated conductor, said process comprising:
(a) coating a conductor with a polymeric coating composition, wherein said polymeric coating composition comprises an ethylene polymer, an organic peroxide, and a polybutadiene;
(b) cross-linking at least a portion of said polymeric coating composition thereby producing a cross-linked polymeric coating composition, wherein said cross-linking produces one or more byproducts, wherein said byproducts comprise methane, acetophenone, or both; and
(c) degassing at least a portion of said cross-linked polymeric coating composition for a degassing time period and at a degassing temperature to remove at least a portion of said byproducts thereby producing a degassed polymeric coating composition,
wherein said degassing time period of step (c) is sufficient to achieve a reduction in methane content and/or acetophenone content of at least 50 wt % and is at least 30% less than the degassing time period required for a reference coated conductor to achieve the same reduction in methane and/or acetophenone content, wherein said methane content reduction and/or acetophenone content reduction is determined from the methane content and/or acetophenone content of said reference coated conductor prior to said degassing for each of said coated conductor and said reference coated conductor,
wherein said reference coated conductor has the same composition and structure, and is prepared in same manner as the coated conductor, except that the polymeric coating composition of the reference coated conductor comprises at least 41 wt % more organic peroxide and does not contain any polybutadiene.

### BRIEF DESCRIPTION OF THE DRAWINGS

FIG. 1 is a plot of time versus byproduct content for the samples prepared in Examples 1 and 2, degassed at 80° C.; and

FIG. 2 is a plot of time versus byproduct content for the samples prepared in Examples 1 and 2, degassed at 175° C.

### DETAILED DESCRIPTION

Various embodiments of the present invention concern a process for producing a coated conductor. The process includes coating a conductor with a polymeric coating composition that comprises an ethylene polymer, an organic peroxide, and a polybutadiene cross-linking coagent. Thereafter, the polymeric composition is cross-linked, followed by degassing.

### Polymeric Coating Composition

The ethylene polymer employed can be any conventional or hereafter discovered ethylene polymer. In an embodiment, the ethylene polymer can be produced using conventional ethylene polymer polymerization technology (e.g., high-pressure, Ziegler-Natta, metallocene, or constrained geometry catalysis). In one embodiment, the ethylene polymer is made using a high pressure process. In another embodiment, the ethylene polymer is made using a mono- or bis-cyclopentadienyl, indenyl, or fluorenyl transition metal (preferably Group 4) catalysts or constrained geometry catalysts (“CGC”) in combination with an activator, in a solution, slurry, or gas-phase polymerization process. The catalyst is preferably mono-cyclopentadienyl, mono-indenyl or mono-fluorenyl CGC. U.S. Pat. No. 5,064,802, WO93/19104 and WO95/00526 disclose constrained geometry metal complexes and methods for their preparation. Variously substituted indenyl-containing metal complexes are taught in WO95/14024 and WO98/49212.

In general, polymerization can be accomplished at conditions known in the art for Ziegler-Natta or Kaminsky-Sinn type polymerization reactions, that is, at temperatures from 0 to 250° C., or 30 or 200° C., and pressures from atmospheric to 10,000 atmospheres (1,013 megaPascal (“MPa”)). In most polymerization reactions, the molar ratio of catalyst to polymerizable compounds employed is from 10⁻¹²:1 to 10⁻¹:1, or from 10⁻⁹:1 to 10⁻⁵:1.

In various embodiments, the ethylene polymer can be an ethylene homopolymer. As used herein, the term “homopolymer” denotes a polymer comprising repeating units derived from a single monomer type, but does not exclude residual amounts of other components used in preparing the homopolymer, such as chain transfer agents.

In an embodiment, the ethylene polymer can be an ethylene/α-olefin interpolymer having an α-olefin content of at least 15, at least 20, and or at least 25 weight percent (“wt %”) based on the weight of the interpolymer. These interpolymers have an α-olefin content of less than 50, less than 45, less than 40, or less than 35 wt % based on the weight of the interpolymer.

When an α-olefin is employed, the α-olefin can be a C₃₋₂₀ (i.e., having 3 to 20 carbon atoms) linear, branched or cyclic α-olefin. Examples of C₃₋₂₀ α-olefins include propene, 1-butene, 4-methyl-1-pentene, 1-hexene, 1-octene, 1-decene, 1-dodecene, 1-tetradecene, 1-hexadecene, and 1-octadecene. The α-olefins can also have a cyclic structure such as cyclohexane or cyclopentane, resulting in an α-olefin such as 3-cyclohexyl-1-propene (allyl cyclohexane) and vinyl cyclohexane. Illustrative ethylene/α-olefin interpolymers include ethylene/propylene, ethylene/butene, ethylene/1-hexene, ethylene/1-octene, ethylene/styrene, ethylene/propylene/1-octene, ethylene/propylene/butene, ethylene/butene/1-octene, and ethylene/butene/styrene.

The ethylene polymers can be used alone or in combination with one or more other types of ethylene polymers (e.g., a blend of two or more ethylene polymers that differ from one another by monomer composition and content, catalytic method of preparation, etc). If the ethylene polymer is a blend of two or more ethylene polymers, then the ethylene polymer can be blended by any in-reactor or post-reactor process.

In an embodiment, the ethylene polymer can have a density from 0.86 to 0.95 gram/cubic centimeter (“cm³), as determined according to ASTM D-792. The ethylene polymer can have a melt index (“I₂”) from 0.1 to 50 gram per 10 minutes (“g/10 min”), as determined according to ASTM D-1238 (190° C./2.16 kg).

Examples of commercially available ethylene polymers that can be employed include very low density polyethylene (“VLDPE”), such as FLEXOMER™ made by The Dow Chemical Company; homogeneously branched, linear ethylene/α-olefin copolymers, such as TAFMER™ by Mitsui Petrochemicals Company Limited, and EXACT™ by Exxon Chemical Company; homogeneously branched, substantially linear ethylene/α-olefin polymers, such as AFFINITY™ and ENGAGE™ available from The Dow Chemical Company; and ethylene block copolymers, such as INFUSE™ ethylene polymer available from The Dow Chemical Company.

The polymeric coating composition further includes an organic peroxide cross-linking agent. As used herein, the term “organic peroxide” shall denote a peroxide having the structure: R¹—O—O—R², or R¹—O—O—R—O—O—R², where each of R¹ and R² is a hydrocarbyl moiety, and R is a hydrocarbylene moiety. As used herein, the term “hydrocarbyl” denotes a univalent group formed by removing a hydrogen atom from a hydrocarbon (e.g. ethyl, phenyl). As used herein, the term “hydrocarbylene” denotes a divalent group formed by removing two hydrogen atoms from a hydrocarbon. The organic peroxide can be any dialkyl, diaryl, dialkaryl, or diaralkyl peroxide, having the same or differing alkyl, aryl, alkaryl, or aralkyl moieties. In an embodiment, each of R¹ and R² is independently a C₁ to C₂₀ or C₁ to C₁₂ alkyl, aryl, alkaryl, or aralkyl moiety. In an embodiment, R can be a C₁ to C₂₀ or C₁ to C₁₂ alkylene, arylene, alkarylene, or aralkylene moiety. In various embodiments, R, R¹, and R² can have the same or a different number of carbon atoms, or any two of R, R¹, and R² can have the same number of carbon atoms while the third has a different number of carbon atoms. Exemplary organic peroxides include dicumyl peroxide; tert-butyl peroxybenzoate; di-tert-amyl peroxide; bis(alpha-t-butyl-peroxyisopropyl)benzene; isopropylcumyl t-butyl peroxide; t-butylcumylperoxide; di-t-butyl peroxide; 2,5-bis(t-butylperoxy)-2,5-dimethylhexane; 2,5-bis(t-butylperoxy)-2,5-dimethylhexyne-3; 1,1-bis(t-butylperoxy)3,3,5-trimethylcyclohexane; isopropylcumyl cumylperoxide; butyl 4,4-di(tert-butylperoxy)valerate; di(isopropylcumyl) peroxide; and mixtures of two or more thereof. In an embodiment, the organic peroxide is dicumyl peroxide.

The polymeric coating composition further includes a polybutadiene cross-linking coagent. The polybutadiene can be any known polybutadiene known or hereafter discovered in the art. As known in the art, polybutadienes have varying structures, as shown in the structure, below:

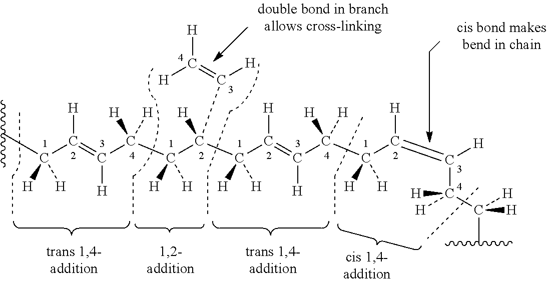

As seen above, polybutadiene can have trans 1,4-vinyl groups, cis 1,4-vinyl groups, and 1,2-vinyl groups. In various embodiments, the polybutadiene cross-linking coagent can have a 1,2-vinyl content of at least 70, at least 80, or at least 85 wt % based on the entire weight of the polybutadiene. In various embodiments, the polybutadiene can have a number average molecular weight (“Mn”) of 10,000 g/mol or less, 8,000 g/mol or less, 6,000 g/mol or less, or 5,000 g/mol or less. In an embodiment, the polybutadiene can be a liquid at 1 atmosphere (˜101.3 kPa) and 22° C. Examples of commercially available polybutadienes include RICON™ 150, RICON™ 152, RICON™ 153, and RICON™ 156, each available from Cray Valley Technology, USA LLC.

In various embodiments, the polymeric coating composition can comprise the ethylene polymer in an amount ranging from 80 to 99 wt %, from 90 to 99 wt %, or from 95 to 98 wt %, based on the combined weight of the ethylene polymer, the organic peroxide, and the polybutadiene. Additionally, the polymeric coating composition can comprise the organic peroxide in an amount ranging from 0.5 to 1.7 wt %, from 0.8 to 1.4 wt %, from 1.0 to 1.4 wt %, from 1.0 to 1.2 wt %, or from 1.1 to 1.2 wt %, based on the combined weight of the ethylene polymer, the organic peroxide, and the polybutadiene. Furthermore, the polymeric coating composition can comprise the polybutadiene in an amount ranging from 0.1 to 10 wt %, from 0.5 to 6 wt %, or from 1.5 to 3 wt %, based on the combined weight of the ethylene polymer, the organic peroxide, and the polybutadiene.

The polymeric coating composition may also contain other additives including, but not limited to, processing aids, fillers, coupling agents, ultraviolet absorbers or stabilizers, antistatic agents, nucleating agents, slip agents, plasticizers, lubricants, viscosity control agents, tackifiers, anti-blocking agents, surfactants, extender oils, acid scavengers, flame retardants, and metal deactivators. Additives, other than fillers, are typically used in amounts ranging from 0.01 or less to 10 or more wt % based on total composition weight. Fillers are generally added in larger amounts although the amount can range from as low as 0.01 or less to 65 or more wt % based on the weight of the composition. Illustrative examples of fillers include clays, precipitated silica and silicates, fumed silica, calcium carbonate, ground minerals, aluminum trihydroxide, magnesium hydroxide, and carbon blacks with typical arithmetic mean particle sizes larger than 15 nanometers.

Additionally, an antioxidant can be employed with the polymeric coating composition. Exemplary antioxidants include hindered phenols (e.g., tetrakis [methylene (3,5-di-t-butyl-4-hydroxyhydrocinnamate)]methane); phosphites and phosphonites (e.g., tris(2,4-di-t-butylphenyl)phosphate); thio compounds (e.g., dilaurylthiodipropionate); various siloxanes; and various amines (e.g., polymerized 2,2,4-trimethyl-1,2-dihydroquinoline). Antioxidants can be used in amounts of 0.1 to 5 wt % based on the total weight of the polymeric coating composition. In the formation of wire and cable compositions, antioxidants are typically added to the system before processing (i.e., prior to extrusion and cross-linking) of the finished article.

Preparation of the polymeric coating composition can comprise compounding the above-described components. Compounding of the polymeric coating composition can be effected by standard equipment known to those skilled in the art. Examples of compounding equipment are internal batch mixers, such as a Brabender™, Banbury™, or Bolling™ mixer. Alternatively, continuous single or twin screw, mixers can be used, such as a Farrel™ continuous mixer, a Werner and Pfleiderer™ twin screw mixer, or a Buss™ kneading continuous extruder. Compounding can be performed at a temperature of greater than the melting temperature of the ethylene polymer up to a temperature above which the ethylene polymer begins to degrade. In various embodiments, compounding can be performed at a temperature ranging from 100 to 200° C., or from 110 to 150° C.

### Coated Conductor

A cable comprising a conductor and an insulation layer can be prepared employing the above-described polymeric coating composition. “Cable” and “power cable” mean at least one wire or optical fiber within a sheath, e.g., an insulation covering or a protective outer jacket. Typically, a cable is two or more wires or optical fibers bound together, typically in a common insulation covering and/or protective jacket. The individual wires or fibers inside the sheath may be bare, covered or insulated. Combination cables may contain both electrical wires and optical fibers. The cable can be designed for low, medium, and/or high voltage applications. Typical cable designs are illustrated in U.S. Pat. Nos. 5,246,783, 6,496,629 and 6,714,707. “Conductor” denotes one or more wire(s) or fiber(s) for conducting heat, light, and/or electricity. The conductor may be a single-wire/fiber or a multi-wire/fiber and may be in strand form or in tubular form. Non-limiting examples of suitable conductors include metals such as silver, gold, copper, carbon, and aluminum. The conductor may also be optical fiber made from either glass or plastic.

Such a cable can be prepared with various types of extruders (e.g., single or twin screw types) by extruding the polymeric coating composition onto the conductor. A description of a conventional extruder can be found in U.S. Pat. No. 4,857,600. An example of co-extrusion and an extruder therefore can be found in U.S. Pat. No. 5,575,965.

Following extrusion, the extruded cable can pass into a heated cure zone downstream of the extrusion die to aid in cross-linking the polymeric coating composition and thereby produce a cross-linked polymeric coating composition. The heated cure zone can be maintained at a temperature in the range of 175 to 260° C. The heated zone can be heated by pressurized steam or inductively heated by pressurized nitrogen gas. In an embodiment, the heated cure zone is a continuous vulcanization (“CV”) tube.

In various embodiments, the cross-linked polymeric coating composition can then be cooled (e.g., to ambient temperature).

The cross-linking process can create volatile decomposition byproducts in the cross-linked polymeric coating composition. The term “volatile decomposition products” denotes decomposition products formed during the curing step, and possibly during the cooling step, by initiation of the free radical generating agent (e.g., dicumyl peroxide). Such byproducts can comprise alkanes, such as methane. Additional byproducts can include alcohols. Such alcohols can comprise the alkyl, aryl, alkaryl, or aralkyl moieties of the above-described organic peroxide. For instance, if dicumyl peroxide is employed as a cross-linking agent, the byproduct alcohol is cumyl alcohol. Other decomposition products can include ketones decomposed from the above-described organic peroxide. For example, acetophenone is a decomposition byproduct of dicumyl peroxide. In one embodiment, “byproducts” shall denote any component that volatilizes at 80° C., at a pressure of 1 atm (101,325 Pa), over a time period of 6 hours.

In various embodiments, the cross-linked polymeric coating composition initially comprises (i.e., before degassing, described below) methane in a maximum amount of 750 parts per million (“ppm”) or less, 700 ppm or less, or 650 ppm or less, based on the entire weight of the cross-linked polymeric coating composition.

Following cross-linking, the cross-linked polymeric coating composition can undergo degassing to remove at least a portion of the volatile decomposition byproducts. Degassing can be performed at a degassing temperature, a degassing pressure, and for a degassing time period to produce a degassed polymeric coating composition. In various embodiments, the degassing temperature can range from 50 to 150° C., or from 60 to 80° C. In an embodiment, the degassing temperature is 65 to 75° C. Degassing can be conducted under standard atmosphere pressure (i.e., 101,325 Pa).

Employing a polybutadiene cross-linking coagent can decrease the amount of time required to degas the polymeric coating composition while maintaining cross-link density. Since degassing time depends not only on composition but also on, among others, the cable size, cable structure, and curing conditions, two indicators can be used to measure the degassing time reduction through composition modification: (1) relative degassing time reduction compared to a reference coated conductor having at least 41 wt % greater organic peroxide loading, based on the combined weight of the polyethylene and the organic peroxide; and (2) percentage in peroxide reduction relative to the polyethylene reference material. These two indicators correlate with each other. For example, since most of the byproduct is decomposed from peroxide, a 50% reduction in degassing time can result from a 29% reduction in peroxide loading to achieve an overall reduction in volatile decomposition byproducts of at least 50 wt %. The reference coated conductor is crosslinked and cooled by the same process and has the same structure and composition as the inventive coated conductor, except not containing any polybutadiene, and containing at least 41% more organic peroxide. Further, preparation and sample dimensions are the same for the reference and inventive coated conductors, including cable size, structure, extrusion coating, curing, cooling and degassing.

When comparing an inventive coated conductor to a reference coated conductor, the byproduct content reduction (for total byproducts as well as individual components) is based on the initial byproduct content (i.e., prior to degassing) of the reference coated conductor for each of the inventive coated conductor and the reference coated conductor. For example, if the reference coated conductor has 1 wt % byproduct content prior to degassing, a reduction to 0.5 wt % byproduct content would be a 50% reduction in byproduct content. Similarly, for the inventive coated conductor, a reduction to 0.5 wt % byproduct content shall be considered a 50% reduction in byproduct content, even if the initial byproduct content of the inventive coated conductor prior to degassing is less than 1 wt %.

In an embodiment, the degassing step is sufficient to achieve at least a 50 wt % reduction in total volatile decomposition byproducts, and is carried out for a time period that is at least 30%, at least 40%, at least 50%, at least 60%, or at least 70% shorter than the degassing time period required for a reference cable to achieve the same 50 wt % reduction of total volatile decomposition byproducts. Total byproduct loss is determined via thermogravimetric analysis (“TGA”) using a temperature ramp of 10° C./min to 80° C., and holding the temperature at 80° C. for 6 hours.

Furthermore, in various embodiments, the degassing time period is sufficient to achieve at least a 50 wt % reduction in methane content, and is carried out for a time period that is at least 30%, at least 40%, at least 50%, at least 60%, or at least 70% shorter than the degassing time period required for the reference cable to achieve the same 50 wt % reduction of methane. Additionally, in various embodiments, the degassing time period is sufficient to achieve at least a 50 wt % reduction in acetophenone content, and is carried out for a time period that is at least 30%, at least 40%, at least 50%, at least 60%, or at least 70% shorter than the degassing time period required for the reference cable to achieve the same 50 wt % reduction of acetophenone. Also, in various embodiments, the degassing time period is sufficient to achieve at least a 50 wt % reduction in cumyl alcohol content, and is carried out for a time period that is at least 30%, at least 40%, at least 50%, at least 60%, or at least 70% shorter than the degassing time period required for the reference cable to achieve the same 50 wt % reduction of cumyl alcohol.

In an embodiment, the inventive cable and the reference cable each achieve a cross-link density sufficient to provide an MH-ML (as described below) of at least 3 deciNewton meters (“dN·m”).

In an embodiment, when the degassing time period is 15 minutes and the degassing temperature is 80° C., at least 65, at least 70, at least 75, or at least 80 wt % of methane is removed from the cross-linked polymeric coating composition, based on the methane content of the cross-linked polymeric coating composition prior to degassing. In various embodiments, when the degassing time period is 15 minutes and the degassing temperature is 80° C., the degassed polymeric coating composition has a methane content of less than 300, less than 250, less than 200, less than 150, or less than 130 ppm.

In an embodiment, when the degassing time is 15 minutes and the degassing temperature is 80° C., the degassed polymeric coating composition has an acetophenone content of less than 0.6, less than 0.5, or less than 0.4 wt %, as determined by head space gas chromatography (“HSGC”), employing the procedures described in the following examples.

In an embodiment, when the degassing time is 60 minutes and the degassing temperature is 80° C., the degassed polymeric coating composition has an acetophenone content of less than 0.5, less than 0.4 or 0.3 wt %, as determined by HSGC of said polymeric coating composition during said degassing.

In an embodiment, when the degassing time is 2.5 minutes and the degassing temperature is 175° C., the degassed polymeric coating composition has a total byproduct content of less than 0.8, less than 0.75, less than 0.7, less than 0.65, less than 0.6, less than 0.55, or 0.5 wt %, as determined by weight loss of said polymeric coating composition during said degassing. Byproduct content can be determined via TGA, using a temperature ramp of 100° C./min to 175° C., and holding at 175° C. for 30 minutes.

In an embodiment, when the degassing time is 30 minutes and the degassing temperature is 80° C., the degassed polymeric coating composition has a total byproduct content of less than 0.6, less than 0.55, or 0.5 wt %, as determined by weight loss of said polymeric coating composition during said degassing. Byproduct content can be determined via TGA, using a temperature ramp of 10° C./min to 80° C., and holding at 80° C. for 6 hours.

The extent of cross-linking in the above-described materials can be determined via analysis on a moving die rheometer (“MDR”) at 182° C. according to ASTM D5289. Upon analysis, an increase in torque, as indicated by the difference between the maximum torque (“MET”) and the minimum torque (“ML”) (“MH-ML”), indicates greater degree of cross-linking. The resulting cross-linked and degassed polymeric coating composition can have an MH-ML of at least 2.5 dN·m, at least 2.75 dN·m, at least 3 dN·m, at least 3.25 dN·m, at least 3.5 dN·m, at least 3.75 dN·m, or at least 3.84 dN·m, with a practical upper limit of 5 dN·m. In an embodiment, the cross-linked and degassed polymeric coating composition can have an MH-ML in the range of from 2.5 dN·m to 3.84 dN·m, in the range of from 2.75 dN·m to 3.84 dN·m in the range of from 3 dN·m to 3.84 dN·m, in the range of from 3.25 dN·m to 3.84 dN·m, in the range of from 3.5 dN·m to 3.84 dN·m, or in the range of from 3.75 dN·m to 3.84 dN·m.

Alternating current cables prepared according to the present disclosure can be low voltage, medium voltage, high voltage, or extra-high voltage cables. Further, direct current cables prepared according to the present disclosure include high or extra-high voltage cables.

### Test Methods

### Sample Preparation

Feed DFDA 4850 ethylene polymer (“PE”) (available from The Dow Chemical Company, Midland, Mich., USA) pellets into a Brabender mixer at 130° C. with a roll speed of 30 rpm and premix the polybutadiene once the PE melts. Mixing time after addition of polybutadiene is 5 min. Heat the resultant compound in an oven at 90° C. for 1 hour, then feed into a two roll mill at 120° C. Once the PE melts, the peroxide is added drop-wise, followed by mixing at roll speed of 12 rpm and roll distance of 0.6 mm for 4 minutes.

Compression Molding to Prepare Cured Plaque with Thickness of 1 mm or 0.3 Mm

Using a Lab Tech LP-S-50/ASTM laboratory hydraulic press, preheat the sample covered by two polyethylene terephthalate (“PET”) membranes in the mold at 130° C. for 5 minutes. Release the air trapped in the sample by operation of plate open/close 8 times. Increase the plate temperature to 182° C. over 5 minutes. Cure the sample under a pressure of 100 kN for 15 minutes. Decrease the plate temperature to 45° C. over 5 minutes.

### Moving Die Rheometer

Perform moving die rheometer (“MDR”) testing at 182° C. according to the methods described in ASTM D5289 on an Alpha Technologies MDR 2000.

### Mechanical (Tensile) Properties

Determine mechanical properties according to ASTM D638 on an Instron model 5565 tensile tester.

### Multiple Headspace Extraction Via Headspace Gas Chromatography

Multiple Headspace Extraction (“MHE”) using Headspace Gas Chromatography (“HSGC”) is performed using the following conditions:

| | |
|---|---|
| Instrumentation | |
| Gas chromatograph | Agilent 6890 |
| Injection port | Split/splitless |
| Column | DB-5MS, 30 m × 0.32 mm × 1.0 mm |
| Detector | FID |
| Sample introduction | G1888 |
| Data collection | ChemStation |
| G1888 Headspace Conditions | |
| GC cycle time | 60 minutes |
| Oven temperature | 150° C. |
| Loop temperature | 160° C. |
| Transfer line temperature | 170° C. |
| Vial equilibration time | 60 minutes |
| Shaking speed | Off |
| Loop fill time | 0.20 minutes |
| Loop equilibration time | 0.05 minutes |
| Inject time | 0.50 minutes |
| Pressurization time | 0.50 minutes |
| Advance functions | Multi HS EXT on; 5 extractions per vial |
| 6890 GC Conditions | |
| Carrier gas (EPC) | Nitrogen, 2.0 mL/min |
| Inlet temperature | 250° C. |
| Split ratio | 1:10 |
| Flow mode | Constant flow |
| FID temperature | 300° C. |
| Oven Program | 40° C., hold for 3 min; |
| | ramp to 280° C. at a rate of 15° C./min; |
| | hold for 5 minutes. (24 min in all) |
| Detector | FID @ 300° C.; |
| | Hydrogen 40 mL/min; Air 450 mL/min; |
| | Make up (Nitrogen) 45 mL/min |

In MHE, the sample is equilibrated at some temperature for a given amount of time and the headspace above the sample is analyzed. This equilibration and measurement process is repeated multiple times and an exponential decrease in the peak areas is observed. About 1.0 g samples are placed into 22-mL headspace vials and analyzed according to the conditions given above.

$${\sum }_{n = 1}^{∞} {A}_{n} = {A}_{1} \text{/} ( 1 - {e}^{- K} ) \qquad Eq . ( 1 )$$

Aₙ=the peak area of the n^{th} injection
A₁=the peak area of the 1^{st} injection
   According to Eq. (1), only two values are needed to calculate the total peak areas: A1, and the constant K. The former is a measured value while the latter can be obtained from linear regression analysis of the following equation:

ln Aₙ=−K(n−1)+ln A₁ Eq. (2):

Having the sum of the peak area values one only needs a calibration factor expressing the relationship between peak area and the concentration (amount) of the analyte.

### Methane Standard Calibration Curve

Inject the following methane amounts into HSGC vials, 200 μl, 400 μl, 500 μl, 600 μl, 800 μl and 1000 μl. Build up the correlation between total peak area

$$( {\sum }_{n = 1}^{∞} {A}_{n} )$$

and methane content. Put two pieces of the sample (prepared as described above) with size of 10 mm*50 mm*1 mm into HSGC vial for HSGC test to get the total peak area

$$( {\sum }_{n = 1}^{∞} {A}_{n} ) .$$

Then prepare a standard calibration curve of area versus μl of methane, and use this standard calibration curve to calculate the methane content based on the total peak area

$$( {\sum }_{n = 1}^{∞} {A}_{n} )$$

for each sample.

### Acetophenone Standard Calibration Curve

The standard samples with different acetophenone loadings are prepared by imbibing the acetophenone into cured samples at 40° C. for different time periods to achieve different acetophenone loading samples. Build up the correlation between total peak area

$$( {\sum }_{n = 1}^{∞} {A}_{n} )$$

and acetophenone loading. Put two pieces of the sample (prepared as described above) with a size of 10 mm*50 mm*1 mm into HSGC vial for HSGC test to get the total peak area

$$( {\sum }_{n = 1}^{∞} {A}_{n} ) .$$

Then prepare a standard calibration curve of area versus percent acetophenone, and use this standard calibration curve to calculate the acetophenone content base on the total peak area

$$( {\sum }_{n = 1}^{∞} {A}_{n} )$$

for each sample.

### EXAMPLES

### Example 1

### Mechanical Analyses

Prepare a comparative sample (CE1) and three samples (E1-E3) according to the weight ratios provided in Table 1, below. The ethylene polymer (“PE”) matrix is DFDA 4850 (available from The Dow Chemical Company, Midland, Mich., USA), a low density polyethylene (“LDPE”) having anti-oxidant blended therein. The dicumyl peroxide (“DCP”) employed has a purity of 99% (available from Shanghai FangRuiDa Chemical, China). The polybutadiene coagent is RICON™ 153 (available from Cray Valley Technology, USA LLC), a liquid polybutadiene resin having a 1,2-vinyl content of 85% and a number average molecular weight of 4,700 g/mol.

TABLE 1
Sample Constitution

Sample:

| | CE1 | E1 | E2 | E3 |
|---|---|---|---|---|
| DFDA 4850 (wt %) | 98.3 | 96.6 | 96.8 | 95.88 |
| DCP (wt %) | 1.7 | 1.4 | 1.2 | 1.12 |
| RICON ™ 153 (wt %) | | 2 | 2 | 3 |
| Total: | 100 | 100 | 100 | 100 |

Prepare the samples for mechanical and dielectric testing according to the sample preparation and compression molding procedures described above.

Analyze each of the samples outlined in Table 1 for mechanical performance according to ASTM D638. Results of these analyses are provided in Table 2, below.

TABLE 2
Curing and Mechanical Performance

| | Sample: | | | |
|---|---|---|---|---|
| | CE1 | E1 | E2 | E3 |
| ML (dN · m) | 0.19 | 0.18 | 0.17 | 0.17 |
| MH (dN · m) | 3.39 | 4.02 | 3.38 | 3.38 |
| MH − ML (dN · m) | 3.2 | 3.84 | 3.21 | 3.21 |
| Tensile Elongation | 580.7 | 505.7 | 524.3 | 416.6 |
| (“TE”) at break (%) | | | | |
| TE Std. Dev. | 14.4 | 8.34 | 31.8 | 12.8 |
| Tensile Strength (“TS”) | 15.33 | 19.62 | 17.67 | 18.47 |
| at break, (MPa) | | | | |
| TS Std. Dev. | 0.64 | 1.14 | 1.07 | 0.99 |

MDR results showed MH-ML increased after the incorporation of RICON™ 153, indicating a higher cross-link density. This result suggests that crosslinking density can be increased by RICON™ 153.

### Example 2

### Degassing Behavior

To simulate degassing behavior, analyze comparative sample CE1 and samples E1 and E2, prepared as described above in Example 1, via thermogravimetric analysis (“TGA”) according to the following procedures. Two temperature regimes are used: 80° C. and 175° C. For the 80° C. TGA (samples CE1 and E2 only), increase temperature to 80° C. at a rate of 10° C./min, then hold at 80° C. for 6 hours. For the 175° C. TGA (samples CE1, E1, and E2), increase temperature to 175° C. at 100° C./min, then hold at 175° C. for 30 minutes. Results of these analyses are provided in Tables 3 and 4, below.

TABLE 3
Weight loss after degassing at 80° C. for 6 h

Sample:

| | CE1 | E2 |
|---|---|---|
| Weight Loss (%) | 1.1 | 0.9 |
| Residue (%) | 98.9 | 99.1 |

TABLE 4
Weight loss after degassing at 175° C. for 30 min

| | Sample: | | |
|---|---|---|---|
| | CE1 | E1 | E2 |
| Weight Loss (%) | 1.3 | 1.1 | 0.8 |
| Residue (%) | 98.7 | 98.9 | 99.2 |

TGA results show that weight loss decreases significantly with use of polybutadiene coagent. The larger the loading of polybutadiene coagent and the lower peroxide loading, the less weight loss of the samples, suggesting that byproducts largely decrease with incorporation of polybutadiene coagent and lower loading of peroxide.

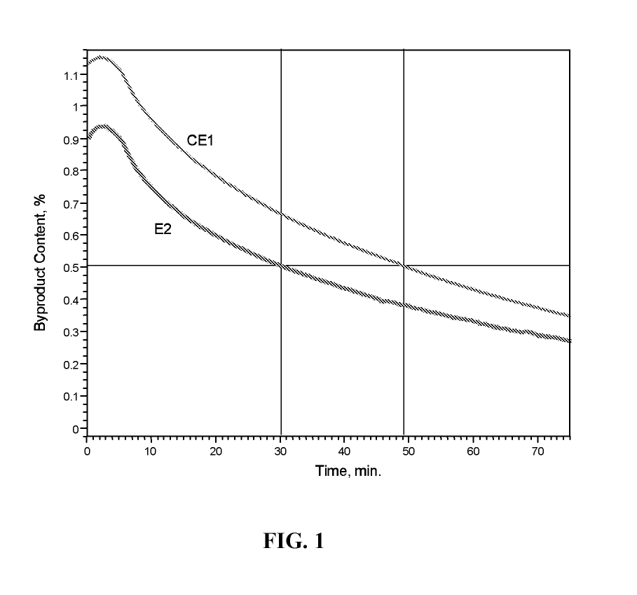

Perform TGA on samples CE1 and E2 at a constant 80° C. according to the above-described TGA procedure. Plots of TGA are provided in FIG. 1. As seen in FIG. 1, it only takes about 30 minutes to reach a byproduct residue level of 0.5% in E2 having the polybutadiene coagent. However, it takes nearly 50 minutes to reach the same byproduct residue level in CE1.

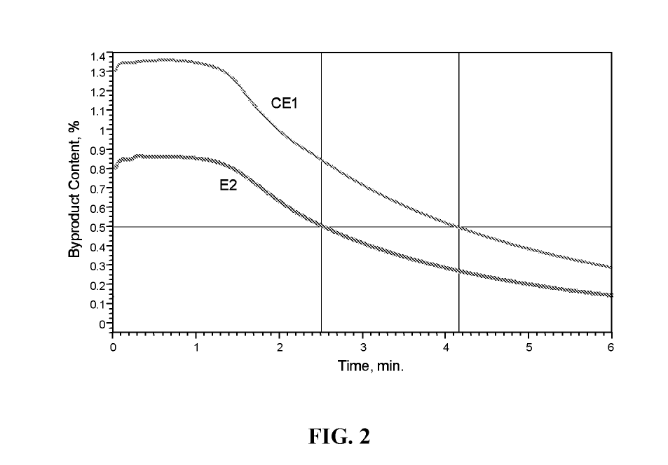

Perform TGA on samples CE1 and E2 at a constant 175° C. according to the above-described TGA procedure. Plots of TGA are provided in FIG. 2. As seen in FIG. 2, it takes only about 2.5 minutes to reach a byproduct residue level of 0.5% in E2 having the polybutadiene coagent. However, it takes nearly 4.2 minutes to reach the same byproduct residue level in CE1.

### Example 3

### Methane and Acetophenone Content Analyses

Measure the amount of methane at start (0 minutes), 15 minutes, and 60 minutes during degassing at 80° C. for samples CE1 and E2. For acetophenone, an additional measurement is taken at 300 minutes. Methane and acetophenone content is determined according to the following procedure:
a. prepare sample plaques according to the compression molding procedures described above;
b. cut the center of the sample plaques into pieces with uniform size 10 mm×50 mm×1 mm with PET membrane still covered on both sides;
c. peel the PET membrane and immediately place them into an oven at 80° C., and degas the samples for the prescribed time periods. Place the 0-minute sample directly into a headspace vial immediately after removing the PET membrane;
d. remove the samples and place them into individual headspace vials after their respective degassing time periods;
e. use MHE via HSGC as described above to detect the methane and acetophenone content. Three specimens are analyzed for each time period.
   Results of methane content analyses are provided in Table 5, below.

TABLE 5
Methane Content Analyses

| Material: | CE1 | E2 |
|---|---|---|
| Methane, 0 min. (ppm) | 863.7 | 637.8 |
| Methane, 15 min. (ppm) | 371.1 | 125.7 |
| Methane, 60 min. (ppm) | 6.6 | 3.3 |

As can be seen in Table 5, after 15 minutes of degassing the sample prepared without the polybutadiene coagent still has nearly three times the amount of methane compared to the sample prepared with the polybutadiene coagent. This indicates that cable coatings prepared with the polybutadiene cross-linking coagent and lower peroxide loading require less degassing time.

Similar results are obtained for acetophenone. Results of the acetophenone content analyses are provided in Table 6, below.

TABLE 6
Acetophenone Content Analyses

| Material: | CE1 | E2 |
|---|---|---|
| Acetophenone, 0 min. (ppm) | 5701.0 | 3854.0 |
| Acetophenone, 15 min. (ppm) | 4074.7 | 2998.0 |
| Acetophenone, 60 min. (ppm) | 3064.8 | 2193.5 |
| Acetophenone, 300 min. (ppm) | 664.5 | 461.3 |

1. A process for producing a coated conductor, said process comprising:
(a) coating a conductor with a polymeric coating composition, wherein said polymeric coating composition comprises an ethylene polymer, an organic peroxide, and a polybutadiene;
(b) cross-linking at least a portion of said polymeric coating composition thereby producing a cross-linked polymeric coating composition, wherein said cross-linking produces one or more byproducts, wherein said byproducts comprise methane, acetophenone, or both; and
(c) degassing at least a portion of said cross-linked polymeric coating composition for a degassing time period and at a degassing temperature to remove at least a portion of said byproducts thereby producing a degassed polymeric coating composition,
wherein said degassing time period of step (c) is sufficient to achieve a reduction in methane content and/or acetophenone content of at least 50 wt % and is at least 30% less than the degassing time period required for a reference coated conductor to achieve the same reduction in methane and/or acetophenone content, wherein said methane content reduction and/or acetophenone content reduction is determined from the methane content and/or acetophenone content of said reference coated conductor prior to said degassing for each of said coated conductor and said reference coated conductor,
wherein said reference coated conductor has the same composition and structure, and is prepared in same manner as the coated conductor, except that the polymeric coating composition of the reference coated conductor comprises at least 41 wt % more organic peroxide and does not contain any polybutadiene.

2. The process of claim 1, wherein when said degassing time period is 15 minutes, said degassing temperature is 80° C., and said cross-linked polymeric coating composition has a thickness of 1 mm, at least 65 wt % of said methane is removed from said cross-linked polymeric coating composition during said degassing of step (c).

3. The process of claim 1, wherein when said degassing time period is 15 minutes, said degassing temperature is 80° C., and said cross-linked polymeric coating composition has a thickness of 1 mm, said degassed polymeric coating composition has a methane content of less than 300 parts per million (“ppm”).

4. The process of claim 1, wherein said degassing time period of step (c) is sufficient to achieve a reduction in total byproduct content of at least 50 wt % and is at least 30% less than the degassing time period required for said reference coated conductor to achieve the same reduction in total byproduct content.

5. The process of claim 1, wherein said cross-linked polymeric coating composition has an MH-ML of at least 3 dN·m, wherein the polymeric coating composition of said reference coated conductor has an MH-ML of at least 3 dN·m.

6. The process of claim 1, wherein said polybutadiene is present in said polymeric coating composition in an amount ranging from 0.1 to 10 weight percent, based on the combined weight of said ethylene polymer, said organic peroxide, and said polybutadiene; wherein said polymeric coating composition comprises said organic peroxide in an amount of less than 1.7 weight percent, based on the combined weight of said ethylene polymer and said organic peroxide; wherein said polymeric coating composition comprises said ethylene polymer in an amount ranging from 80 to 99 weight percent based on the combined weight of said ethylene polymer, said organic peroxide, and said polybutadiene.

7. The process of claim 1, wherein said polybutadiene has a 1,2-vinyl content of at least 80 weight percent based on the entire weight of said polybutadiene, wherein said polybutadiene has a number average molecular weight of 10,000 g/mol or less.

8. The process of claim 1, wherein said organic peroxide is dicumyl peroxide, wherein said byproducts further comprise acetophenone and cumyl alcohol.

9. A cable prepared according to the process of claim 1.

10. The cable according to claim 9, wherein said cable is a medium voltage, high voltage, or extra-high voltage cable.
